(19) United States
(12) Patent Application Publication
(10) Pub. No.: US 2025/0048023 A1
(43) Pub. Date: Feb. 6, 2025

(54) SPEAKER SUSPENSION SYSTEM

(71) Applicant: Logitech Europe S.A., Lausanne (CH)

(72) Inventors: Cheng Chia Pan, Hsinchu County (TW); Wen Hung Huang, Hsinchu County (TW); Ching-Lung Lan, Hsinchu City (TW)

(21) Appl. No.: 18/790,584

(22) Filed: Jul. 31, 2024

Related U.S. Application Data
(60) Provisional application No. 63/517,249, filed on Aug. 2, 2023.

(51) Int. Cl. H04R 1/28; H04M 1/03; H04R 1/02; H04R 1/08

(52) U.S. Cl. CPC H04R 1/2896; H04M 1/035; H04R 1/025; H04R 1/08

(57) ABSTRACT

A teleconferencing system includes a system housing, a speaker enclosure configured within the system housing, a speaker mounted to the speaker enclosure, and one or more damping elements coupling the speaker enclosure to the system housing. The one or more damping elements suspend the speaker enclosure within the system housing such that the speaker enclosure is isolated and separated from the system. In some cases, the one or more damping elements provide the only structural coupling between the speaker enclosure and the system housing. The damping elements are laterally attached directly to the speaker housing with a resilient element.

### CROSS REFERENCE PARAGRAPH FOR PRIORITY

This application claims the benefit and priority of U.S. Provisional Application No. 63/517,249, filed on Aug. 2, 2023, and titled “SPEAKER SUSPENSION SYSTEM,” which is hereby incorporated by reference in its entirety for all purposes.

### BACKGROUND

Teleconference systems (e.g., conference phones) often include a particular type of phone that is well-suited for use in telephone conference calls with multiple people calling from multiple different geographic locations. A typical teleconference device may be similar to a conventional mobile phone in that it may include a keypad to dial phone numbers and, in some cases, a display to render data relevant to the call including the phone number, participant names, a local time, the length of the call, and the like, but typically does not include a handset. Rather, teleconference devices often include a loudspeaker to allow all participants to hear the conversation and a microphone to enable hands-free use.

Teleconference systems have improved as new generations are introduced into the market. For instance, high fidelity speakers and microphones can be found on contemporary devices. Some modern displays offer richer content, improved resolution, sleeker user interfaces, and greater functionality. In many modern teleconference systems, video conferencing may be integrated with the audio for a more engaging communication experience.

Despite the many improvements in teleconference systems, many teleconference systems still incorporate suboptimal design choices and performance tradeoffs to accommodate certain performance specifications that continue to plague even the more contemporary high end systems. Thus, continued innovation is needed to address the inherent design flaws that necessitate these performance tradeoffs to make for better quality, more robust, and higher fidelity teleconference systems. One such improvement is found in U.S. Pat. No. 10,694,283, which provides a suspension system with damping cushions. It would be desirable to have an improved damping system that is easier and less expensive to manufacture and/or has the same or better damping qualities.

### BRIEF SUMMARY

In some embodiments, a teleconferencing system may include a system housing, a speaker enclosure configured within the system housing, a speaker mounted to the speaker enclosure, and one or more damping elements coupling the speaker enclosure to the system housing. The one or more damping elements suspend the speaker enclosure within the system housing such that the speaker enclosure is isolated and separated from the system. In some cases, the one or more damping elements may provide the only structural coupling between the speaker enclosure and the system housing. The damping elements are laterally attached directly to the speaker housing with a resilient element.

In some implementations, the damping elements may be ring-shaped with extending members directly connected through openings in a speaker housing. The ring-shaped portion is attached to a supporting pole like a washer. Ridges on the ring providing vertical damping with respect to the pole. The one or more damping elements may be formed of a non-rigid and pliable compound, such as rubber, polyurethane, elastomer (e.g., thermoplastic elastomer), or other type with similar properties. The one or more damping elements can be configured to dampen the mechanical energy generated by the speaker and coupled to the system housing in three dimensions.

In further embodiments, each of the one or more damping elements may be mounted in a particular axis, and where each of the one or more damping elements provides dampening of the vibrational energy vibrating along both the mounted axis and at least one axis orthogonal to the mounted axis (in some cases in 3 axes).

The teleconferencing system may further include one or more microphones disposed in the system, where the one or more damping elements can be further configured to reduce an amount of mechanical energy generated by the speaker and coupled to the microphone via the one or more damping elements.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The detailed description is set forth with reference to the accompanying figures.

FIG. 1 shows a typical teleconference system.

FIG. 2 shows a typical teleconference system subject to mechanical vibrations caused by direct coupling a speaker enclosure to a system housing.

FIG. 3 shows a speaker housing 300 coupled to a system housing, according to the design of prior art U.S. Pat. No. 10,694,283.

FIG. 4 is a perspective, exploded view of an embodiment with a laterally suspended speaker housing according to embodiments.

FIG. 5 is a perspective view of the embodiment of FIG. 4 with the resilient members attached and the speaker cover and speaker removed, according to embodiments.

FIG. 6 is a perspective view of the embodiments of FIGS. 4 and 5 showing the assembled speaker housing and damping element, according to embodiments.

FIG. 7 is an exploded view of the speaker housing and resilient elements according to embodiments.

FIG. 8 is a simplified block diagram of a system for operating a teleconference system, according to certain embodiments.

### DETAILED DESCRIPTION

Embodiments of this invention are generally directed to communication devices. More specifically, some embodiments relate to a teleconference system using an integrated and isolated speaker system for improved audio performance.

In the following description, for the purpose of explanation, numerous examples and details are set forth in order to provide an understanding of embodiments of the present invention. It will be evident, however, to one skilled in the art that certain embodiments can be practiced without some of these details, or with modifications or equivalents thereof.

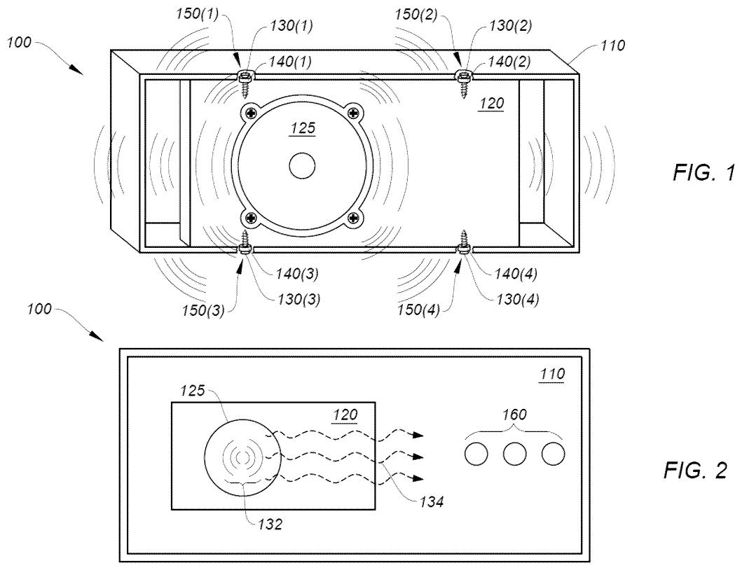

In many contemporary teleconference systems, speaker enclosures are often integrated within the system housing (e.g., the housing that usually contains all of the primary communications electronics, including microphones, audio/video processing systems, etc., and typically sits on a table or other surface). Some examples of a contemporary system are shown in FIGS. 1-2. In operation, audio that is output by the speaker(s) is typically a voice of one or more participants originating from a different location (e.g., voice audio received by a party on the opposite end of the line). The voice is often amplified loud enough for all participants in the teleconference to hear the conversation. In some systems, a microphone may also be integrated within the system housing. The microphone(s) are often used to detect voice and other local audio, which is then transferred to the other participants at the other locations to facilitate two-way communication. However, the microphone(s) can also detect audio generated by the speaker, which if unchecked, can generate a positive feedback loop resulting in undesired audio effects and poor system performance. For example, the positive feedback loop may manifest as high-pitched audio feedback, continuous echoes of increasing amplitude, and other deleterious parasitic effects. Many systems typically utilize echo cancellation to detect audio generated by the speakers and actively cancel or suppress it to minimize the positive feedback loop, as would be understood by those of ordinary skill in the art.

Despite the ability to cancel audio generated by the speaker, integrated speakers typically generate mechanical vibrations that can be propagated throughout the teleconference system. These mechanical vibrations can cause “rub and buzz” in the system and may include vibrations in system components (e.g., capacitors, wires, harnesses, printed circuit boards, etc.), which can ultimately propagate these vibrations to the on-board microphone. The mechanical vibrations often manifest as vibrations in the audio spectrum (e.g., typically 100 Hz-1000 Hz) that conventional systems cannot differentiate from other audio sources (e.g., other participant voice or audio signals), and the mechanical vibration is usually comprised of a different frequency or frequencies than the audio generated by the speaker because mechanical vibrations caused by the speaker do not necessarily track the audio (e.g. voice) generated by the speaker. Therefore, contemporary echo cancellation systems are typically not equipped to recognize and differentiate parasitic mechanical vibrations detected by the microphone from legitimate voice signals from local teleconference participants. Thus, to avoid the risk of accidentally attenuating legitimate and intended voice signals (not generated by the speaker), the mechanical vibrations are often left unmitigated. As a result, certain audio performance characteristics may suffer including double talk, echo cancellation, total harmonic distortion, perceptual rub and buzz, and the overall frequency response of the system. A common but suboptimal method of reducing these types of performance degradation is to attenuate microphone sensitivity while certain audio frequencies are generated by the speaker, such that a near half-duplex form of communication occurs. As would be appreciated by one or ordinary skill in the art, this can be a very undesirable system performance characteristic.

One prior art solution to the problem of mechanical vibrations propagating throughout the teleconference system (also referred to as a “teleconference device”) is to mount and mechanically isolate the speaker/enclosure (often referred to as a “suspended speaker housing”) within the system housing using damping cushions, as shown in U.S. Pat. No. 10,694,283. The damping cushions operate to couple the suspended speaker housing to the system housing and presents the only path for which mechanical vibrations generated by the speaker can travel. As such, mechanical vibrations induced by the speaker can be highly attenuated before ever reaching the microphone(s) due to the material/mechanical properties of the damping cushions. Since little to no mechanical vibrations are detected by the microphone, very little parasitic positive feedback caused by the vibrations is passed through the communication channel. This can result in a marked improvement in the performance characteristics mentioned above.

By way of example, some implementations of a teleconferencing system according to embodiments of the invention include a system housing, a speaker enclosure configured within the system housing, a speaker mounted to the speaker enclosure, and one or more damping elements that couple directly to the speaker enclosure laterally, as opposed to the vertical cushions of U.S. Pat. No. 10,694,283. The one or more damping elements suspend the speaker enclosure within the system housing such that the speaker enclosure is isolated and separated from the system housing by at least a minimum distance (e.g., 2 mm). The one or more damping elements may be configured to dampen mechanical energy generated by the speaker and coupled to the system housing. The damping elements have a resilient portion that connects directly to the speaker housing, and are mounted on a rigid member (e.g., supporting pole) connected to the system housing. The resilient portion of the damping elements may be comprised of a pliable compound such as rubber (e.g., silicone), polyurethane (“PU”), or other polymer to dampen the mechanical energy generated by the speaker and coupled to the system housing (and ultimately the microphone). In some embodiments, materials can range from different types of foams, plastics, and rubbers (e.g., natural or synthetic, such as Nitrile, EPDM, SBR, silicone, etc.), which can be selected based on a number of criteria not limited to cost, its ability to absorb energy, moldability, tensile/compression strength, compression set at temperature high/low ranges (e.g., for speaker enclosure loading, orientations, etc.), flame retardance level (e.g., UL 94-V1 min, environmental considerations (e.g., UV, extreme temperatures, chemicals, etc.), and the like.

In some implementations, dampening effects may exceed 6 dB or more and some damping elements may exhibit a non-linear force response profile. Some embodiments of these novel features and more are described below in the embodiments that follow.

Many of the embodiments that follow include basic configurations of teleconference systems that may comprise a speaker, speaker housing (e.g., speaker enclosure), a system housing, and microphones. It should be understood that these examples are simplified in order to teach the novel concepts described herein and to prevent the obfuscation of concepts germane to the novelty for the sake of complexity. One of ordinary skill in the art with the benefit of this disclosure would understand that many variations, modifications, and alternative embodiments of the teleconference systems are possible, and that the various embodiments, features, components, and the like, described in the group of figures that follow may be combined in any suitable manner.

FIG. 1 shows a typical teleconference system 100. Teleconference system (“system”) 100 includes a speaker 125 directly mounted to a speaker enclosure 120. Speaker enclosure 120 is directly mounted inside and fastened to system housing 110 using conventional hardware including screws 130(1-4) and grommets 140 (1-4). Grommets are typically comprised of a solid, dense plastic or rubber. Typical systems 110 may utilize any suitable hardware including pins, tabs, mounting systems, rivets, screws (e.g., shoulder screws), washers, locking nuts, brackets, or other suitable hardware that can be used to fasten and secure speaker enclosure 120 to system housing 110. Foam inserts are sometimes used to lower manufacturing costs, but typically only in systems without on-board microphones as they can negatively affect audio performance characteristics of the teleconference system, as described below. Other types of fasteners can be found in conventional systems including friction mounted sleeves (e.g., speaker enclosure 120 is friction mounted inside a sleeve and secured therein) embedded within system housing 110, as would be appreciated by one of ordinary skill in the art with the art.

Conventional systems utilizing integrated speakers are often subject to mechanical vibrations caused by the speaker(s) that may be propagated throughout the teleconference system. These mechanical vibrations can cause rub and buzz (“R&B”) in the system and may include vibrations in system components (e.g., capacitors, wires, harnesses, printed circuit boards, etc.) or even the housing(s) themselves, which can ultimately propagate these vibrations to the on-board microphone. The propagation of mechanical vibrations may occur by speaker enclosure 120 directly contacting with and transferring mechanical vibrations to system housing 110. Mechanical vibrations can also be propagated 150(1-4) through the fastening hardware (e.g., screws 130(1-4) and grommets 140 (1-4), which are good conductors of mechanical energy. In some cases, wire harnesses coupled to speaker 125 and one or more structures (e.g., PCBs, sockets, etc.) of system housing 110 may be a conduit for mechanical vibrations. Other potential conduits of mechanical energy may exist, as would be appreciated by one of ordinary skill in the art. As described above, mechanical vibrations often manifest as vibrations in the audio spectrum that conventional systems such as system 100 cannot differentiate from other audio sources. Some typical problem frequencies range between 50 Hz and 1000 Hz. In some cases, the resonance frequency of the speaker enclosure tends to vibrate the system the most, which typically ranges from 80 Hz to 300 Hz (in the voice spectrum), although other ranges are possible. The voice spectrum is typically 100 Hz-1 kHz, although some may consider 100 Hz-3 kHz or 300 Hz-3 kHz to define the voice spectrum, as would be appreciated by one of ordinary skill in the art. Consequently, mechanical vibrations are usually comprised of a different frequency or frequencies than the audio generated by the speaker, and therefore, contemporary echo cancellation systems are typically not equipped to recognize and differentiate parasitic mechanical vibrations detected by the microphone from legitimate voice signals from local teleconference participants. A simplified example of this phenomenon is depicted in FIG. 2, which shows both reproduced audio 132 and mechanical vibrations 134 generated by speaker 125 reaching microphones 160. As indicated above, mechanical vibrations can cause rub and buzz, which may detrimentally affect certain performance characteristics including double talk, echo cancellation, total harmonic distortion (“THD”), and the overall frequency response of the system.

Some conventional systems address these types of performance degradation by attenuating microphone sensitivity while certain audio frequencies are generated by the speaker, such that a near half-duplex form of communication occurs. In some systems, other means are used to attenuate the amount of vibrations coupled from the system housing to the microphones. For instance, glue or other adhesive is often used to secure components to prevent them from buzzing. Harnesses may be used to keep vibrating wires from contacting other components. In some cases, foam and other insulating materials may be used to further reduce mechanical vibrations. However, these solutions often add significant costs to manufacturing, reduce product yields, and typically do not reduce the mechanical vibrations that reach the microphone to a degree that produces even marginal improvements in the performance characteristics described above.

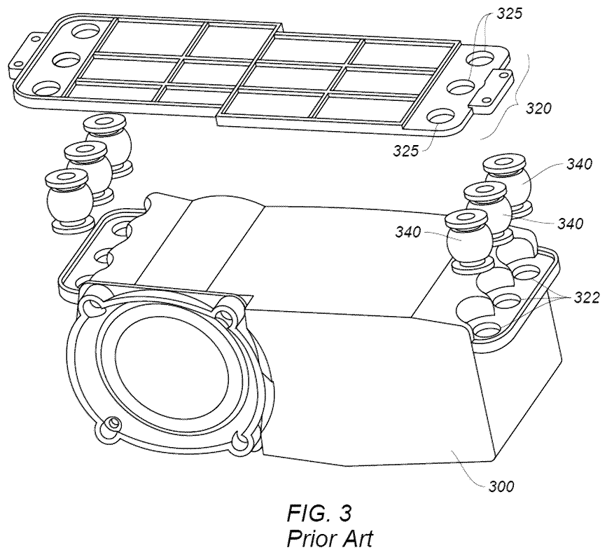

FIG. 3 shows a speaker housing 300 coupled to a system housing, according to the design of prior art U.S. Pat. No. 10,694,283 of the same assignee as the present application. Cushion holder 320 (shown as a mounting plate), when the teleconference system is fully assembled, may be directly coupled to the system housing. Speaker housing 300 can be coupled to the system housing via one or more damping cushions. For example, an upper flange of damping cushion 340 may couple to the system housing by way of a corresponding retention hole 325 of cushion holder 320, and a lower flange of damping cushion 340 may couple to speaker housing 300 by way of a corresponding retention hole 322.

### Embodiments Using a Laterally Suspended and Isolated Speaker Housing

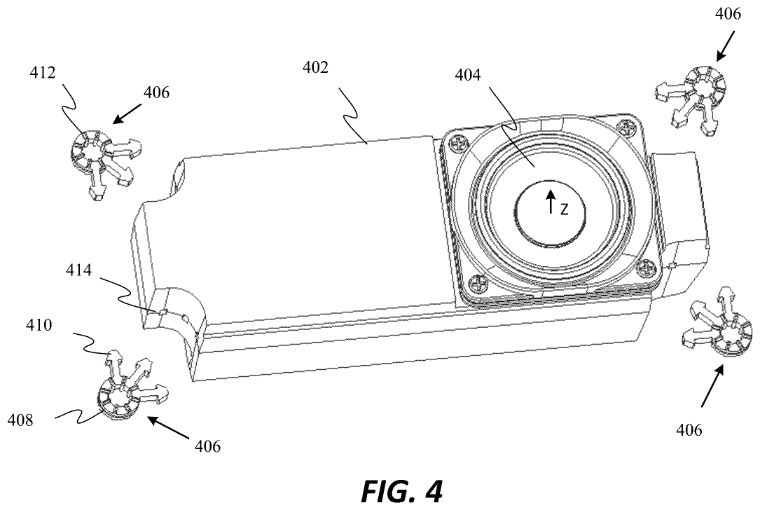

FIG. 4 is a perspective, exploded view of an embodiment with a laterally suspended speaker housing according to embodiments. A speaker housing 402 is shown, with an exposed speaker driver 404. A number of resilient elements 406 for suspending the speaker housing are shown. Each resilient element 406 is integrally formed with a ring 408 and three protruding members 410 and a series of ridges 412 on both the top and bottom of the ring. The protruding members engage with holes 414 in the speaker housing to provide a direct connection and support of the speaker housing.

The members 410 extend toward the speaker housing in a direction orthogonal to the direction of movement of the speaker driver (Z direction), which is roughly in and out of the page as shown.

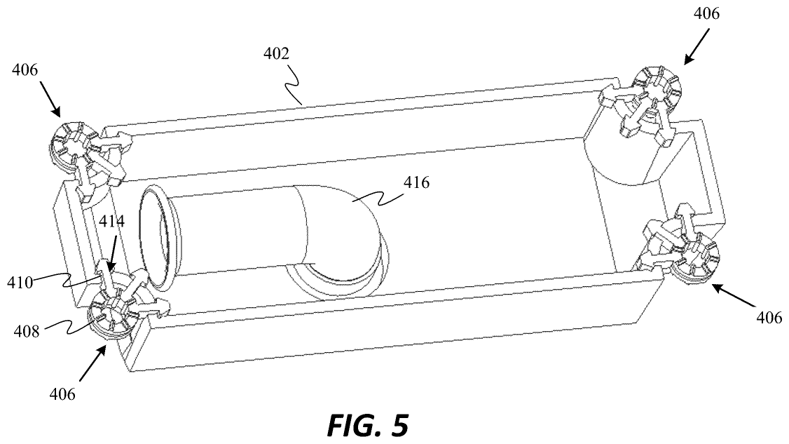

FIG. 5 is a perspective view of the embodiment of FIG. 4 with the resilient members attached and the speaker cover and speaker removed, according to embodiments. The port tube 416 of the speaker is visible inside the speaker housing. As can be seen, members 410 have been pushed through holes 414 in the speaker housing 402. The pointed ends of members 410 and their resiliency and deformability allow them to be compressed as they press through the hole, which is smaller than the arrowhead shape at the end of members 410. Once through the hole, the arrowhead tip expands to secure the resilient member to the speaker housing. The angle between the three shown members for each resilient element prevent the members from extending too far into the speaker housing. As shown, they are each separated by 45 degrees, with the outer members being parallel to a speaker wall and separated by 90 degrees. In one embodiment, a wider ring portion of the member (integral to the member, but like a washer), keeps the member from sliding too far into the speaker housing.

In an alternate embodiment, resilient elements 406 could be manufactured with the speaker housing using inset molding. Insert molding uses preformed resilient elements that are loaded into a mold, where it is then over molded with plastic or other material to create the speaker housing with the resilient elements already attached. Using insert molding, the attachment can be by alternate methods, such as using a threaded end of members 410 instead of the arrowhead, with the speaker plastic molding to the threads to create a strong connection. Alternately, a bulb or other shape could be used instead of the arrowhead. Alternately, instead of insert molding, the resilient element could have an undercut feature to allow the arrowhead tips that connect with the speaker housing to be ‘locked’ from the inside.

In one embodiment, the resilient elements 406 are made of silicone rubber with hardness A shore 40°-A shore 50°. The ribs 408 improve the damping performance in the Z direction. The members 410 provide damping in all X, Y and Z directions. Additional damping in the Z direction is provided by the ring providing a cushioning effect against the supporting pole.

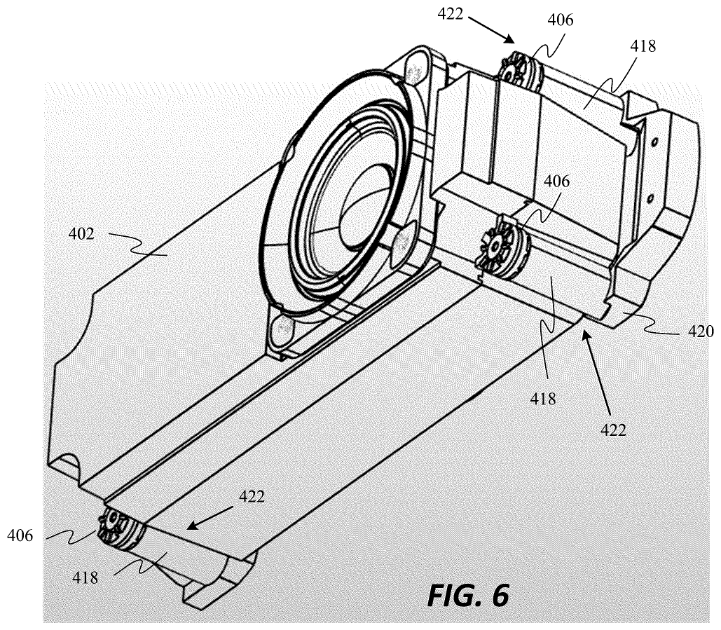

FIG. 6 is a perspective view of the embodiments of FIGS. 4 and 5 showing the assembled speaker housing and damping element, according to embodiments. Each of the resilient elements 406 has a support pole 418 extending through its ring. The combination of support pole 418 and resilient element 406 forms a damping element 422. The support poles 418 are attached to a system housing plate 420. System housing plate 420 can be integral with the system housing, or can be a plate bolted, welded, glued, or otherwise attached to the system housing. Alternately, a damping cushion may attach plate 420 to the system housing to provide additional damping.

The extending members 410 provide resiliency along all 3 X, Y and Z axes. In addition, the ring and the ridges can deform and expand, providing additional resiliency, primarily in a direction parallel to an axis extending through the middle of the ring. The ring portion of resilient element 406 acts like a washer against the hard surface of the interior of support pole 418, with the ridges providing damping of motion against the pole in a vertical direction.

As shown in FIG. 6, poles 420 are attached to a single side of the system housing. Alternately, the pole could attach to two sides, extending upward in the view of FIG. 6 to attach to an upper system housing plate as well. Alternately, the poles could extend only from the top plate. In another embodiment, some poles could extend from the top, and other poles could extend from the bottom plate of a system housing.

Variations can be used in alternate embodiments. The arrowhead shape could be replaced with a mushroom shape, for example. Alternately, a ring or block shape at the end of members 410 could be used, with the ends being placed in half the holes 414 before two halves of the speaker housing are connected. Alternatively, a different number of members 410 could be used, such as 2 or 4. In another embodiment, the three members are webbed together, with a thinner material integrally connecting them up to the arrowhead ends. Alternatively, a solid piece can be used with just the extending arrowheads or other extending form.

Although four damping elements (resilient elements 406 and poles 418) are shown, additional damping elements could be connected to the speaker housing from the sides or from the top and/or bottom.

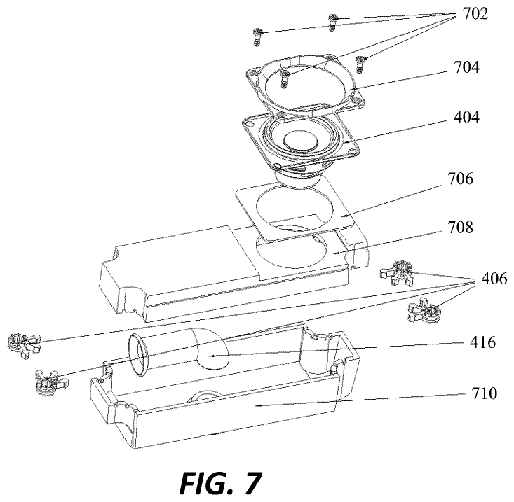

FIG. 7 is an exploded view of the speaker housing and resilient elements according to embodiments. At the top, screws 702 are used to attach a diffuser 704 to the speaker driver 404. A rubber top 706 is positioned between the speaker driver 404 and a front enclosure 708 of the speaker housing. The resilient elements 406 are positioned to engage the holes in back enclosure 710 of the speaker housing, with a port tube 416 of the speaker inside.

To address the problems with mechanical vibrations described above, aspects of the present invention relate a suspended speaker housing that is integrated with the system housing but mechanically isolated from it. In such an implementation, mechanical vibrations in the suspended speaker housing would not mechanically transfer to the system housing because there would be no physical path to conduct the mechanical vibrations. Some vibrations may be transferred from the suspended speaker housing to the system housing over the air, but the attenuation over even a very small air gap (e.g., 2 mm) would be substantial enough to effectively eliminate mechanical vibrations detected at the microphones. The embodiments described herein typically refer to a gap between the suspended speaker housing and the system housing of at least 2 mm, which can accommodate for most typical manufacturing and assembly tolerances while still maintaining an acceptable air gap for sufficient attenuation. The 2 mm gap is also sufficient to absorb most movement of the suspended speaker housing within the system housing due to movement of the teleconference system/device itself, or movements caused by the operation of the speaker. Note that other gap sizes that are smaller or larger than 2 mm may be used, as would be appreciated by one of ordinary skill in the art with the benefit of this disclosure.

Isolating and suspending the speaker housing within the system housing may be achieved using any suitable means. Some of the embodiments described herein use one or more damping elements to both suspend the speaker housing within the system housing and mechanically isolate the two. A damping element may have a resilient element which includes a ridged disk (FIG. 4) or a rubber bulb, although other shapes are contemplated. For instance, some resilient elements may be a cylindrical shape, a spherical shape, a bellows shape, or other suitable configuration. In some cases, the damping cushions are hollow and typically have an even thickness. Some embodiments of the resilient element are air filled but open ended, which has excellent vibrational attenuation properties. Alternatively, some embodiments may using resilient elements that are closed off and filled with a suitable gas (e.g., air), gels, or similar compressible materials. In some embodiments, resilient elements can have a hardness (durometer) of Shore A 40° ˜50°, though other values are possible, such as Shore A 35°-55° or Shore A 30°-60°.

In certain embodiments, the damping elements are the only structural coupling elements configured to couple the isolated speaker housing and the system housing. In this context, structural coupling may refer to how the speaker housing is assembled and secured within the system housing. In some cases, other components such as speaker wires or harnesses may be mechanically coupled to the system housing, but such components are not structural elements as they do not operate to secure the speaker housing within the system housing in a manner that would be appreciated by one or ordinary skill in the art with the benefit of this disclosure. Although not discussed in detail, other isolation techniques are contemplated including foam-based coupling cushions, electromagnetic suspension systems, or other suitable method that effectively isolates mechanical vibrations generated by the speaker to the speaker enclosure. Thus, the use of a suspended and mechanically isolated speaker housing eliminates the need to control vibrations in the system housing via glue, cable harnesses, foam inserts, or other remedial measures, which are far less effective, more costly, and subject to inconsistent performance characteristics.

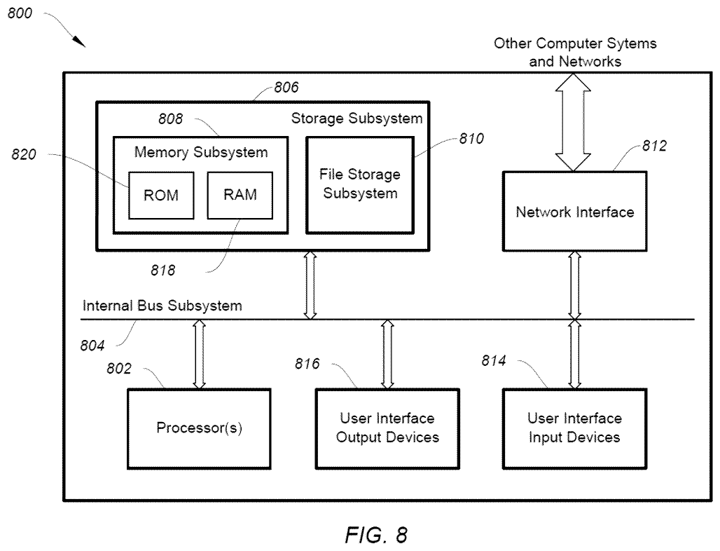

FIG. 8 is a simplified block diagram of a teleconference system (“system”) 800 for operating a teleconference system, according to certain embodiments. System 800 can be used to implement any of the teleconference devices discussed above with respect to FIGS. 3-7. Computer system 800 can include one or more processors 802 that can communicate with a number of peripheral devices (e.g., input devices) via a bus subsystem 804. These peripheral devices can include storage subsystem 806 (comprising memory subsystem 808 and file storage subsystem 810), user interface input devices 814, user interface output devices 816, and a network interface subsystem 812.

In some examples, internal bus subsystem 804 can provide a mechanism for letting the various components and subsystems of computer system 800 communicate with each other as intended. Although internal bus subsystem 804 is shown schematically as a single bus, alternative embodiments of the bus subsystem can utilize multiple buses. Additionally, network interface subsystem 812 can serve as an interface for communicating data between computer system 800 and other computer systems or networks. Embodiments of network interface subsystem 812 can include wired interfaces (e.g., Ethernet, CAN, RS232, RS485, etc.) or wireless interfaces (e.g., ZigBee, Wi-Fi, cellular, etc.).

In some cases, user interface input devices 814 can include a buttons and/or controls for interfacing with the teleconference system, one or more cameras (e.g., for video conferencing), audio input devices (e.g., one or more microphones, voice recognition systems), a keyboard (hardware or soft keyboard), pointing devices (e.g., mouse, trackball, touchpad, etc.), a touch-screen incorporated into a display, Human Machine Interfaces (HMI) and other types of input devices. In general, use of the term “input device” is intended to include all possible types of devices and mechanisms for inputting information into system 800. Additionally, user interface output devices 816 can include a display subsystem, or non-visual displays such as audio output devices, etc. The display subsystem can be any known type of display device. In general, use of the term “output device” is intended to include all possible types of devices and mechanisms for outputting information from system 800.

Storage subsystem 806 can include memory subsystem 808 and file/disk storage subsystem 810. Subsystems 808 and 810 represent non-transitory computer-readable storage media that can store program code and/or data that provide the functionality of embodiments of the present disclosure. In some embodiments, memory subsystem 808 can include a number of memories including main random-access memory (RAM) 818 for storage of instructions and data during program execution and read-only memory (ROM) 820 in which fixed instructions may be stored. File storage subsystem 810 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 800 is illustrative and not intended to limit embodiments of the present disclosure. Many other configurations having more or fewer components than system 800 are possible.

The various embodiments further can be implemented in a wide variety of operating environments, which in some cases can include one or more user computers, computing devices or processing devices, which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local-area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A teleconferencing system comprising:
a system housing;
a speaker enclosure configured within the system housing;
a speaker mounted to the speaker enclosure; and
one or more damping elements coupling the speaker enclosure to the system housing, wherein the one or more damping elements suspend the speaker enclosure within the system housing such that the speaker enclosure is isolated and separated from the system housing by at least a minimum distance,
wherein the one or more damping elements provide the only structural coupling between the speaker enclosure and the system housing, and
wherein the one or more damping elements are directly connected to the speaker enclosure with a resilient member.

2. The teleconferencing system of claim 1 wherein the resilient member includes a ring with at least one extending member connected to the speaker housing and the damping elements include a support pole extending through the ring and connected to the system housing.

3. The teleconferencing system of claim 2 wherein the ring has a plurality of extending ridges to provide additional damping in a Z-direction.

4. The teleconferencing system of claim 1 wherein the one or more damping elements are configured to support and suspend the speaker housing within the system housing along three dimensions.

5. The teleconferencing system of claim 1 further comprising:
a microphone disposed in the system housing,
wherein the one or more damping elements are further configured to reduce an amount of mechanical energy generated by the speaker and coupled to the microphone via the one or more damping elements.

6. The teleconferencing system of claim 1 wherein the one or more damping elements dampen audio spectrum mechanical energy generated by the speaker and mechanically coupled to the system housing by at least 6 dB.

7. The teleconferencing system of claim 6 wherein the audio spectrum is a voice spectrum of 100 Hz-3000 Hz.

8. The teleconferencing system of claim 1 wherein the one or more damping elements have a non-linear force response profile.

9. The teleconferencing system of claim 1 wherein the minimum distance is 2 mm.

10. The teleconferencing system of claim 2 wherein the resilient member is silicone rubber with hardness of Shore A 35°-55°.

11. A teleconferencing system comprising:
a system housing;
a speaker enclosure configured within the system housing;
a speaker mounted to the speaker enclosure; and
one or more damping elements coupling the speaker enclosure to the system housing, wherein the one or more damping elements suspend the speaker enclosure within the system housing such that the speaker enclosure is isolated and separated from the system housing by at least a minimum distance,
wherein the one or more damping elements provide the only structural coupling between the speaker enclosure and the system housing,
wherein the one or more damping elements are directly connected to the speaker enclosure with a resilient member, and
wherein the resilient member includes a ring with at least one extending member connected to the speaker housing and the damping elements include a support pole extending through the ring and connected to the system housing.

12. The teleconferencing system of claim 11 wherein the one or more damping elements comprise four damping elements connected to four corners of the speaker housing, and wherein each corner of the speaker housing has an inward curve to accommodate the ring and support pole of the damping element.

13. The teleconferencing system of claim 11 wherein the at least one extending member connected to the speaker housing further comprises three extending members engaging openings in the speaker housing.

14. The teleconferencing system of claim 13 wherein each of the three extending members has an arrow-shaped tip sized to allow insertion into the openings by compression of the arrow-shaped tip, and retention within the openings by re-expansion of the arrow-shaped tip after insertion.

15. The teleconferencing system of claim 13 wherein a first extending member is parallel to a wall of the speaker housing, a second extending member is at an angle of 45 degrees to the first extending member and a third extending member is at an angle of 90 degrees to the first extending member.

16. The teleconferencing system of claim 11 wherein the ring has a plurality of extending ridges to provide additional damping in a Z-direction.

17. The teleconferencing system of claim 11 further comprising:
a microphone disposed in the system housing, and
wherein the one or more damping elements are further configured to reduce an amount of mechanical energy generated by the speaker and coupled to the microphone via the one or more damping elements.

18. The teleconferencing system of claim 11 wherein the one or more damping elements have a non-linear force response profile.

19. The teleconferencing system of claim 11 wherein the resilient member is silicone rubber with hardness of Shore A 35°-55°.

20. A teleconferencing system comprising:
a system housing;
a speaker enclosure configured within the system housing;
a speaker mounted to the speaker enclosure; and
one or more damping elements coupling the speaker enclosure to the system housing, wherein the one or more damping elements suspend the speaker enclosure within the system housing such that the speaker enclosure is isolated and separated from the system housing by at least a minimum distance,
wherein the one or more damping elements provide the only structural coupling between the speaker enclosure and the system housing,
wherein the one or more damping elements are directly connected to the speaker enclosure with a resilient member,
wherein the resilient member includes a ring with at least one extending member connected to the speaker housing and a support pole extending through the ring and connected to the system housing,
wherein the ring has a plurality of extending ridges to provide additional damping in a Z-direction,
a microphone disposed in the system housing, and
wherein the one or more damping elements are further configured to reduce an amount of mechanical energy generated by the speaker and coupled to the microphone via the one or more damping elements.
